(19) United States
(12) Patent Application Publication
(10) Pub. No.: US 2026/0333204 A1
(43) Pub. Date: Oct. 22, 2026

(54) USING DOWNLINK WAKE-UP SIGNAL (DLWUS) TO INDICATE THE PHYSICAL DOWNLINK CONTROL CHANNEL (PDCCH) MONITORING FOR 6G RADIO IDLE MODE USER EQUIPMENT (UE)

(71) Applicant: Lenovo (United States) Inc., Morrisville, NC (US)

(72) Inventors: Karthikeyan Ganesan, Nauheim (DE); Ali Ramadan Ali, Kraiburg (DE); Ravi Kuchibhotla, Chicago, IL (US)

(73) Assignee: Lenovo (United States) Inc., Morrisville, NC (US)

(21) Appl. No.: 19/464,468

(22) Filed: Jan. 29, 2026

(51) Int. Cl. H04W 48/14; H04W 52/02

(52) U.S. Cl. CPC H04W 48/14; H04W 52/0235

(57) ABSTRACT

Various aspects of the present disclosure relate to using downlink wake-up signal (DLWUS) to indicate the physical downlink control channel (PDCCH) monitoring for 6GR idle mode user equipment (UE). An apparatus, such as a UE, requests an on-demand system information block type 1 (OD-SIB1) activation for a cell using an invalid monitoring occasion for search space monitoring. The UE activates the OD-SIB1 using the invalid monitoring occasion as part of the search space monitoring occasion indication, and determines whether to monitor a PDCCH occasion associated with the OD-SIB1.

### TECHNICAL FIELD

The present disclosure relates to wireless communications, and more specifically to network energy savings (NES) for user equipment (UE).

### BACKGROUND

A wireless communications system may include one or multiple network communication devices, which may be otherwise known as network equipment (NE), supporting wireless communications for one or multiple user communication devices, which may be otherwise known as UE, or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to request an on-demand system information block type 1 (OD-SIB1) activation for a cell using an invalid monitoring occasion for search space monitoring. Search space monitoring occasion indication may be part of a master information block (MIB) payload. The UE may activate the OD-SIBI using the invalid monitoring occasion as part of the search space monitoring occasion indication. The UE may determine whether to monitor a physical downlink control channel (PDCCH) occasion associated with the OD-SIB1.

A processor (e.g., a standalone processor chipset, or a component of a UE) for wireless communication is described. The processor may be configured to, capable of, or operable to perform one or more operations as described herein. For example, the processor may be configured to, capable of, or operable to request an OD-SIBI activation for a cell using an invalid monitoring occasion for search space monitoring. Search space monitoring occasion indication may be part of a MIB payload. The processor may activate the OD-SIBI using the invalid monitoring occasion as part of the search space monitoring occasion indication. The processor may determine whether to monitor a PDCCH occasion associated with the OD-SIB1.

A method performed or performable by a UE for wireless communication is described. The method may include requesting an OD-SIBI activation for a cell using an invalid monitoring occasion for search space monitoring, activating the OD-SIBI using the invalid monitoring occasion as part of the search space monitoring occasion indication, and/or determining whether to monitor a PDCCH occasion associated with the OD-SIB1. The search space monitoring occasion indication may be part of a MIB payload.

In some implementations of the UE, the processor, and the method described herein, the UE may monitor a downlink (DL) wake-up signal (WUS) occasion. The DL WUS occasion may be a group common associated with a system information radio network temporary identifier (SI-RNTI) of the OD-SIB1. The UE may receive indication on the DL WUS on whether to start PDCCH monitoring in a search space associated with a SI-RNTI of the OD-SIB1. The UE may receive monitoring occasions for the search space monitoring related to a SI-RNTI as part of the MIB payload. Upon determining that the monitoring occasions for the search space monitoring related to the SI-RNTI is valid, the UE may monitor the PDCCH occasion associated with the OD-SIB1.

In some implementations of the UE, the processor, and the method described herein, the UE, the processor, and the method may further be configured to, capable of, operable to, performed to, or performable to receive a change of the MIB payload associated with the search space associated with a SI-RNTI of the OD-SIB1. The change of the MIB payload may be determined by comparing a MIB payload from a previous MIB occasion or MIB modification period. The change of the MIB payload may mean content of the search space monitoring occasions associated with the SI-RNTI is changed from invalid to valid. The UE may receive indication on a DL WUS on whether to start the PDCCH monitoring occasion associated with a SI-RNTI of the OD-SIB1.

An NE (e.g., a base station) for wireless communication is described. The NE may be configured to, capable of, or operable to perform one or more operations as described herein. For example, the NE may be configured to, capable of, or operable to provide a cell with an OD-SIB1 activation using an invalid monitoring occasion for search space monitoring, and activate the OD-SIB1 using the invalid monitoring occasion as part of the search space monitoring occasion indication. The search space monitoring occasion indication may be part of a MIB payload.

A processor (e.g., a standalone processor chipset, or a component of a NE) for wireless communication is described. The processor may be configured to, capable of, or operable to perform one or more operations as described herein. For example, the processor may be configured to, capable of, or operable to provide a cell with an OD-SIB1 activation using an invalid monitoring occasion for search space monitoring, and activate the OD-SIB1 using the invalid monitoring occasion as part of the search space monitoring occasion indication. The search space monitoring occasion indication may be part of a MIB payload.

A method performed or performable by an NE (e.g., a base station) for wireless communication is described. The method may include providing a cell with an OD-SIB1 activation using an invalid monitoring occasion for search space monitoring, and activating the OD-SIB1 using the invalid monitoring occasion as part of the search space monitoring occasion indication. The search space monitoring occasion indication may be part of a MIB payload.

### BRIEF DESCRIPTION OF THE DRAWINGS

FIG. 1 illustrates an example of a wireless communications system in accordance with aspects of the present disclosure.

FIGS. 2a-3c illustrate example systems in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of an NE in accordance with aspects of the present disclosure.

FIG. 7 illustrates a flowchart of a method performed by a UE in accordance with aspects of the present disclosure.

FIG. 8 illustrates a flowchart of a method performed by an NE in accordance with aspects of the present disclosure.

### DETAILED DESCRIPTION

On-demand SIB1 (OD-SIB1) framework is discussed in fifth generation new radio (5GNR) using assistance information from Cell A to enable the OD-SIB1 for NES cell. In the sixth generation radio (6GR), standalone NES operation is being considered too. Although the OD-SIB1 provides network energy savings, an event-based triggering of OD-SIB1 based on UL WUS or network initiated paging method results in the device power consumption due to the fact that UE(s) may need to monitor all PDCCH monitoring occasions related to OD-SIB1. The event-based triggering of OD-SIB1 may mean OD-SIB1 is transmitted when an explicit trigger occurs, where the trigger is either a UE-initiated uplink wake-up signal (UL-WUS), or a network-initiated paging action indicating UE presence or pending data.

In a wireless communications system, a UE and an NE (e.g., a base station, gNB) may support wireless communication (e.g., reception and/or transmission of wireless communication) using time-frequency resources.

Aspects of the present disclosure are described in the context of a wireless communications system, and include implementations that minimize the PDCCH or search space monitoring occasions linked to OD-SIB1. OD-SIB1 is OD-SIB1 is an on-demand version of SIB1 that is transmitted when triggered by UE or network events, instead of being periodically broadcast, to reduce power and signaling overhead. SIB1 contains essential cell access information, such as cell access and barring information, scheduling information for other SIBs, and/or paging-related parameters. Various embodiments and cases are described herein to reduce power and signaling overhead in wireless communication.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

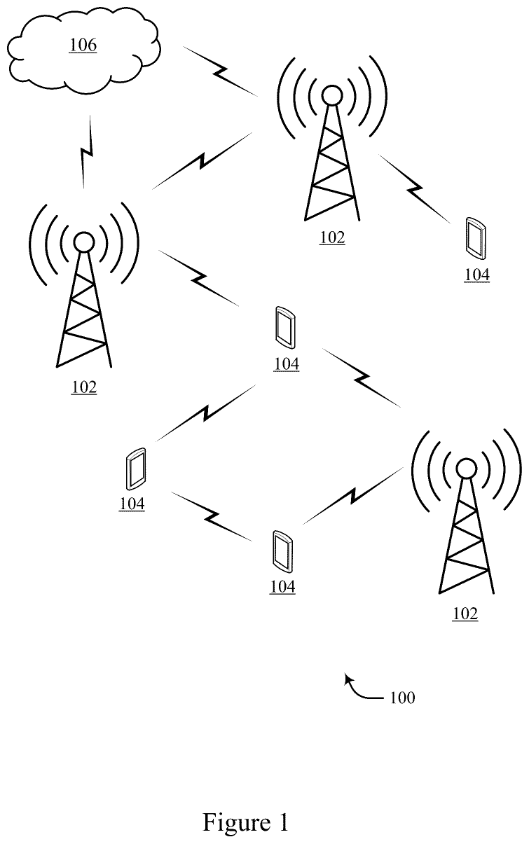

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHZ-24.25 GHz), FR4 (52.6 GHz-114.25 GHz), FR4a or FR4-1 (52.6 GHZ-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 may request an on-demand system information block type 1 (OD-SIB1) activation for a cell using an invalid monitoring occasion for search space monitoring. Search space monitoring occasion indication may be part of a master information block (MIB) payload. The UE may activate the OD-SIBI using the invalid monitoring occasion as part of the search space monitoring occasion indication. The UE may determine whether to monitor a physical downlink control channel (PDCCH) occasion associated with the OD-SIB1. An NE 102 (e.g., a base station, gNB) communicates provide a cell with an OD-SIB1 activation using an invalid monitoring occasion for search space monitoring, and activate the OD-SIBI using the invalid monitoring occasion as part of the search space monitoring occasion indication. The search space monitoring occasion indication may be part of a MIB payload.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

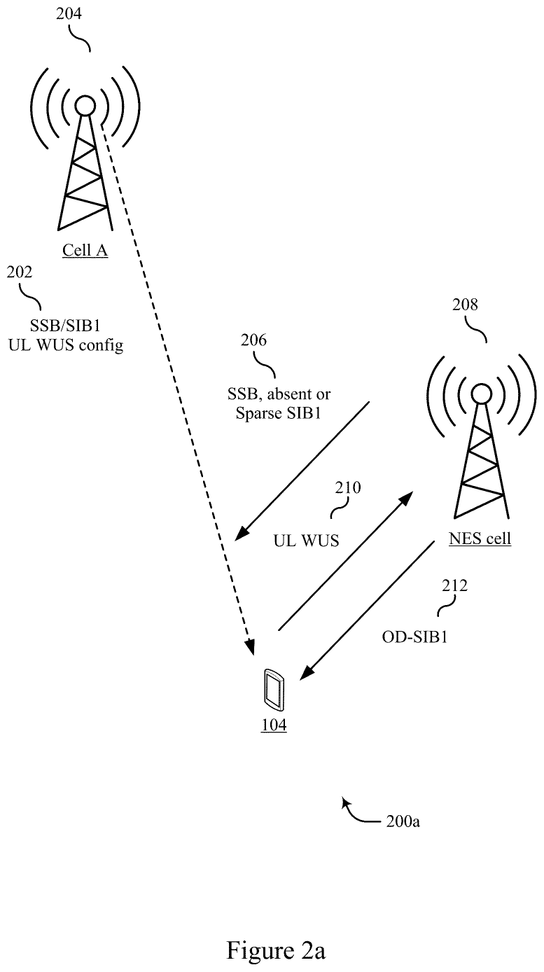

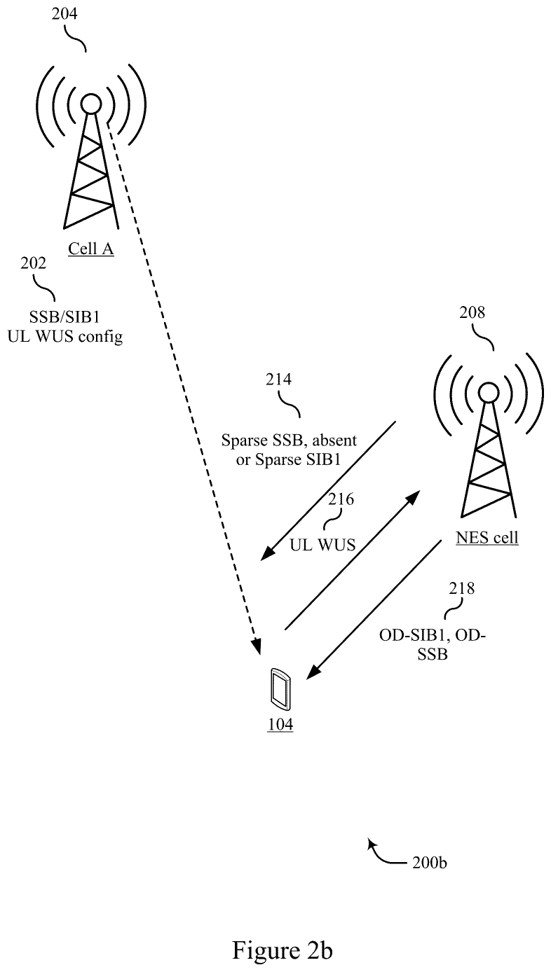

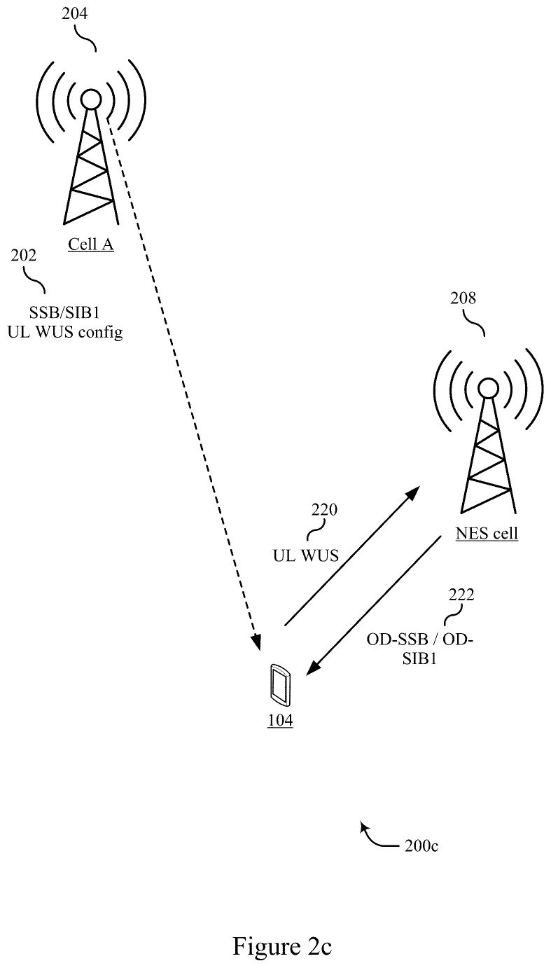

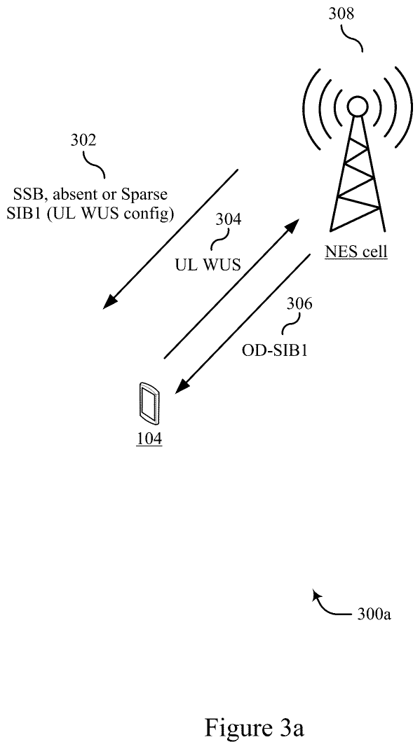

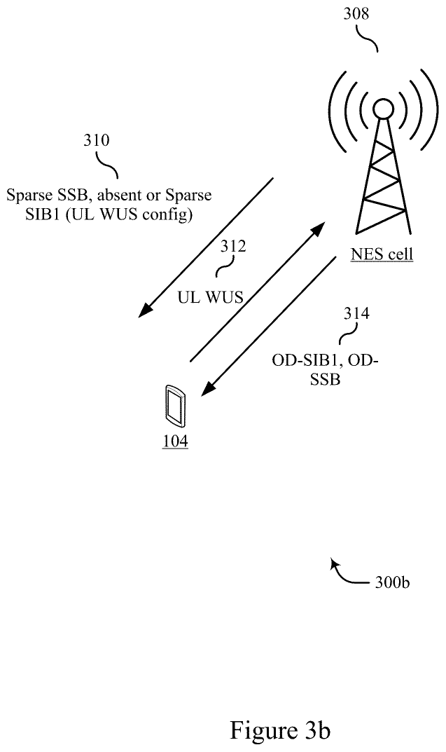

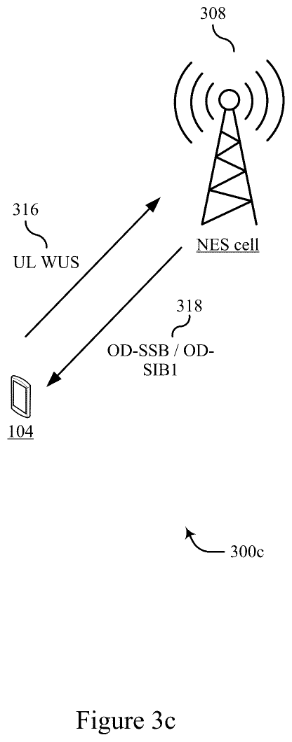

FIGS. 2a-2c and 3a-3c show different cases of UL-WUS configuration and transmission to request on-demand SSB, on-demand SIB1, or both. In case of non-stand-alone deployment (case 2a, 2b, 2c) UL-WUS configuration may be obtained from assistant cell (cell A), while UL-WUS is transmitted towards NES cell to wake-up and send on-demand broadcast signals. Although WUS-configuration is easier and straightforward, the overall energy saving is limited. In case of stand-alone deployment scenarios (cases 3a, 3b, 3c), UL-WUS can be obtained from the sparse SIB1 or from SSB in cases 3a and 3b. However, in case 3c, for which high energy saving gain can be obtain as BS is in deep sleep state with no SSB transmission, UL-WUS configuration is not available at the UE to transmit UL-WUS. A new procedure may be required to enable transmitting UL-WUS.

FIG. 2a illustrates a system 200a in accordance with aspects of the present disclosure. In the system 200a, a UL-WUS configuration and transmission to request on-demand SSB or on-demand SIB1 may be performed. At 202, a Cell A 204 (e.g., a NE 102) may transmit a SSB or SIB1 which includes a UL WUS configuration to a UE 104. At 206, an NES cell 208 (e.g., a NE 102) may transmit SSB, absent or sparse SIB1 to the UE 104. At 210, the UE 104 may transmit UL WUS to the NES cell 208. At 212, the NES cell 208 may transmit OD-SIB1 to the UE 104.

FIG. 2b illustrates a system 200b in accordance with aspects of the present disclosure. In the system 200b, a UL-WUS configuration and transmission to request on-demand SSB or on-demand SIB1 may be performed. At 202, a Cell A (e.g., a NE 102) may transmit a SSB or SIB1 which includes a UL WUS configuration to a UE 104. At 214, an NES cell 208 (e.g., a NE 102) may transmit sparse SSB, absent or sparse SIB1 to the UE 104. At 216, the UE 104 may transmit UL WUS to the NES cell 208. At 218, the NES cell 208 may transmit OD-SIB1 or OD-SSB to the UE 104.

FIG. 2c illustrates a system 200c in accordance with aspects of the present disclosure. In the system 200c, a UL-WUS configuration and transmission to request on-demand SSB or on-demand SIB1 may be performed. At 202, a Cell A (e.g., an NE 102) may transmit a SSB or SIB1 which includes a UL WUS configuration to a UE 104. At 220, the UE 104 may transmit UL WUS to the NES cell 208 (e.g., a NE 102). At 222, the NES cell 208 may transmit OD-SIB1 or OD-SSB to the UE 104.

FIG. 3a illustrates a system 300a in accordance with aspects of the present disclosure. In the system 300a, a UL-WUS configuration and transmission to request on-demand SSB or on-demand SIB1 may be performed. At 302, an NES cell 308 (e.g., a NE 102) may transmit SSB, absent or sparse SIB1 (UL WUS configuration) to the UE 104. At 304, the UE 104 may transmit UL WUS to the NES cell 308. At 306, the NES cell 308 may transmit OD-SIBI to the UE 104.

FIG. 3b illustrates a system 300b in accordance with aspects of the present disclosure. In the system 300b, a UL-WUS configuration and transmission to request on-demand SSB or on-demand SIB1 may be performed. At 310, an NES cell 308 (e.g., a NE 102) may transmit sparse SSB, absent or sparse SIB1 (UL WUS configuration) to the UE 104. At 312, the UE 104 may transmit UL WUS to the NES cell 308. At 314, the NES cell 308 may transmit OD-SIB1 or OD-SSB to the UE 304.

FIG. 3c illustrates a system 300c in accordance with aspects of the present disclosure. In the system 300c, a UL-WUS configuration and transmission to request on-demand SSB or on-demand SIB1 may be performed. At 316, the UE 104 may transmit UL WUS to the NES cell 308 (e.g., a NE 102). At 318, the NES cell 308 may transmit OD-SIB1 or OD-SSB to the UE 104.

Aspects of the present disclosure include solutions to minimize the PDCCH or search space monitoring occasions linked to OD-SIB1. There may be multiple cases here to consider for power saving at the UE side. For example, in one case, OD-SIBI is received by the UE transmitting UL WUS. In another case, OD-SIB1 is received by all UE(s) in a cell even though one UE or a subset of UE(s) transmits UL WUS. In a third case, OD-SIB1 is initiated by network-initiated paging, and UE monitors paging occasion and receive message on receiving an indication for OD-SIB1.

In radio resource control (RRC) idle state, the low power wake up receiver (LP-WUR) may monitor wake up signal and serving cell measurements. In RRC connected state, the LP-WUR may replace DCI 2_6-wake-up MR for C_DRX active time, dynamic active timer configuration.

Agreement had been made on study and evaluate DL WUS of OFDM based sequence and corresponding mechanisms for 6GR EE improvement, regarding at least the following aspects: coverage target for DL WUS (e.g., same as PDCCH, common sync signal, or other), measurements and/or synchronization, system overhead and network energy consumption/UE energy saving for UE operation with the DL WUS, RRC states, and/or other functionalities.

Agreement had been made on study and evaluate on-demand and/or periodic SIB-1 transmission with respect to network (NW) energy savings potential and UE power consumption impact, SIB-1 acquisition delay, NW and UE complexity, Coverage, and/or applicable deployment scenarios. For example, applicable deployment scenarios may be standalone cell/carrier, or multiple transmission reception points (TRPs)/cells/carriers.

TABLE 1

| | Search | | |
|---|---|---|---|
| Type | Space | RNTI | Use Case |
| Type0-PDCCH | Common | SI-RNTI for RMSI on a primary cell | SIB Decoding (SIB1) |
| Type0A-PDCCH | Common | SI-RNTI on a primary cell | SIB Decoding (Other |
| | | | SIBs) |
| Type1-PDCCH | Common | RA-RNTI, TC-RNTI, C-RNTI on a | Msg2, Msg4 decoding in |
| | | primary cell | RACH |
| Type2-PDCCH | Common | P-RNTI on a primary cell | Paging Decoding |
| Type3-PDCCH | Common | INT-RNTI, SFI-RNTI, TPC-PUSCH- | |
| | | RNTI, TPC-PUCCH-RNTI, TPC- | |
| | | SRS-RNTI, C-RNTI, CS-RNTI(s), | |
| | | SP-CSI-RNTI | |
| UE-SS | UE | C-RNTI, or CS-RNTI(s), or SP-CSI- | User specific PDSCH |
| | Specific | RNTI | decoding |

Table 1 illustrates different types of search spaces, their related RNTI and corresponding use cases.

TABLE 2

| Type | Signaling Parameters |
|---|---|
| Type0-PDCCH | Type0-PDCCH > pdcch-ConfigSIB1 in MasterInformationBlock |
| | Type0-PDCCH > searchSpaceSIB1 in PDCCH-ConfigCommon |
| | Type0-PDCCH > searchSpaceZero in PDCCH-ConfigCommon |
| Type0A-PDCCH | Type0-PDCCH > seachSpaceOtherSystemInformation in |
| | PDCCHConfigCommon |
| Type0-PDCCH > | Type0-PDCCH > ra-SearchSpace in PDCCH-ConfigCommon |
| Type1-PDCCH | |
| Type2-PDCCH | Type0-PDCCH > pagingSearchSpace in PDCCH-ConfigCommon |
| Type3-PDCCH | Type0-PDCCH > SearchSpace in PDCCH-Config with |
| | search SpaceType = common |
| UE Specific | Type0-PDCCH > SearchSpace in PDCCH-Config with |
| | searchSpaceType = ue-Specific |

Table 2 illustrates different types of search spaces and their corresponding signaling parameters.

UE may skip PDCCH monitoring for SIB1 when OD-SIBI is configured and monitor PDCCH only when the UL WUS is sent. However, this concept has a drawback. For example, if one of the two UEs sends UL WUS for OD-SIB1, the other UE requests OD-SIB1 but would not receive the OD-SIBI when the other UE does not monitor the PDCCH. Solutions are provided herein to address this drawback.

In one embodiment, OD-SIB1 may be received by the UE transmitting UL WUS. In aspects of this disclosure, when a cell is configured with OD-SIB1 and when UE already acquired SIB1, the UE may skip monitoring the occasions related to search space and/or DCI format associated to the SI-RNTI. The SI-RNTI may be the RNTI linked to the on-demand SIB1.

The UE may monitor the occasions related to search space and/or DCI format associated to the SI-RNTI after UE transmits the UL WUS. When UE does not acquire a SIB1, the UE may monitor the next monitoring occasions related to search space and/or DCI format after the UL WUS transmission or the next modification period of SIB1, or a BS may configure a gap period between the UL WUS transmission and monitoring of occasions related to search space and/or DCI format.

In another embodiment, OD-SIB1 may be received by all UE(s) in a cell even though one UE or a subset of UE(s) transmits UL WUS. In aspects of this disclosure, when a cell is configured with OD-SIB1 and a UE in a cell transmits UL WUS to request OD-SIB1, there may be an issue that other UEs that are not transmitting UL WUS may not be able to monitor the search space and/or DCI format associated to the SI-RNTI configured for OD-SIB1. There may be a few options to address this issue. The first option is that UE may be configured to monitor DL WUS occasion which can be group common associated to SI-RNTI of OD-SIB1. Then UE may receive indication on the DL WUS on whether to start PDCCH monitoring in a search space and/or DCI format associated to the SI-RNTI.

For the second option, the BS may indicate the monitoring occasions of search space and/or DCI formats related to SI-RNTI of OD-SIB1 as part of the MIB payload. When OD-SIB1 is configured, BS may not indicate a valid (or invalid) monitoring occasions for the search space and/or DCI format monitoring associated to the SI-RNTI. When a UE receives a valid monitoring occasion for the search space and/or DCI format monitoring associated to the SI-RNTI, then UE may monitor for the PDCCH associated to the SI-RNTI or search space and/or DCI format monitoring associated to the SI-RNTI. An OD-SIB1 activation in a cell may be provided by using an invalid monitoring occasions for the search space monitoring and/or DCI format monitoring or PDCCH associated to the SI-RNTI. Therefore, when a UE receives the change of MIB payload content associated to the search space or DCI formats associated to SI-RNTI configured for OD-SIB1, the change of MIB payload may be provided by comparing the MIB payload from the previous MIB occasion or MIB modification period. The change of MIB payload means the content of the search space and/or DCI format monitoring occasions associated to the SI-RNTI can be changed from invalid to valid.

In a third embodiment, OD-SIB1 is initiated by network-initiated paging, and UE monitors paging occasion and receive message on receiving an indication for OD-SIB1. In aspects of this disclosure, a cell may initiate the updated SIB1 content by notification using the DL WUS which can be group common associated to SI-RNTI of OD-SIB1. The UE may receive indication on the DL WUS on whether to start PDCCH monitoring in a search space and/or DCI format associated to the SI-RNTI.

In a fourth embodiment, when a cell is configured with on-demand SSBs, a UE in a cell may transmit UL WUS to request the transmission of OD-SSB. However, other UEs that are not transmitting UL WUS may not be able to monitor the OD-SSB. In this case, UE(s) may receive indication on the DL WUS when BS transmits OD-SSBs. DL-WUS may be commonly configured for plurality of UEs in a cell.

In a fifth embodiment, in 5G NR, for each Downlink Bandwidth Part (BWP), the network may configure up to 10 search spaces (including both common and UE-specific search space) for the UE to monitor. These search spaces are associated with CORESETs (Control Resource Sets), which defines the physical resource regions allocated for PDCCH monitoring. To support diverse devices types and optimize UE power-saving configurations and indications, the number of UE dedicated search spaces to monitor can be statically configured or dynamically indicated, benefiting UEs with constrained power (e.g., an IoT devices) and those operating in an energy efficient mode. A DL-WUS configuration may indicate, prior to the start of the on-duration timer or prior to the slot as part of the side information, the search space to monitor, DCI sizes, DCI formats, PDCCH candidates or a combination thereof. Similarly, number of C RNTIs in a slot can be minimized to one from three in an EE state so that UE in an EE state monitors only a specific RNTI or only one C_RNTI.

In another embodiment, HARQ-ACK feedback in response to PDCCH reception can help UE and network remain aligned regarding commands issued by the network. The commands may be the BWP switching, adaptation command, any group specific command such as Cell DTX/DRX, or any common channel/signals periodicity adaptation as part of network energy savings command. It is necessary to study a subset of DCI format that support this feedback mechanism, especially for DCI format in UE-specific search space or group common DCI scrambled with a specific RNTI aiming to enhance the reliability of PDCCH reception and ensure proper reception of network commands. The specific RNTI may indicate the BWP switching, network energy commands etc. A UE can be configured via RRC signal to determine which DCI format and whether to provide feedback upon a PDCCH reception. A common PUCCH resource with ACK and NACK resource, ACK only or NACK only resources may be configured semi-statically. When a UE has a CRC failure during decoding, DCI may indicate NACK to the BS. When a UE is able to decode the DCI, DCI may indicate an ACK to the BS.

In one implementation, for low-tier devices with limited supported bandwidth (e.g., 3-5 MHz) or for devices with larger supported bandwidth (e.g., 20 MHz) but configured with small BWP for operating in EE processing state, it may be beneficial to extend the CORESET duration (e.g., to 6 or 12 OFDM symbols) to support larger aggregation levels (e.g., at least AL=16). For example, assuming 5 MHz bandwidth with 15 kHz SCS, up to 24 RBs per symbol can be allocated to the CORESET. To support AL=16, at least four symbols are required, and a larger number of symbols (CORESET duration, e.g., 6 or 12 symbols) can further reduce PDCCH blocking probability. Such extension of CORESET duration for narrow bandwidth devices can be achieved using within a slot or using inter-slot symbols aggregation. Inter-slot CORESET symbol aggregation can be applied for delay tolerant traffic type and UE can start the PDSCH processing only when UE receives all CORESET symbols. Considering that there are a limited number of DL symbols within a slot for certain TDD DL/UL configurations, and that some DL symbols may be reserved for PDSCH scheduling within a slot, the extended symbols for an enhanced CORESET can be configured as continuous or non-continuous symbols within a slot and even span across multiple slots. In one implementation, CORESET aggregation can be performed using CCE-to-REG bundle mapping from plurality of CORESETs from the first slot and the second slots or CORESET symbols within a slots, where the REGs of these CORESETs can be aggregated to form a CCE. For example, CORESET has 2 symbol in the first slot and 2 symbol in the second slot, then the REG bundle size can be set to 4, meaning a CCE is formed with by aggregating 2 REGs from the first two symbol of first slot and 2 REGs from the second symbol of second slot. In another implementation, a REG indexing and/or CCE indexing can be performed across slots, where the REG index/CCE index of first two symbols of CORESET from first slot is aggregated with that of the REG index/CCE index of first two symbols of CORESET from second slot. Thereby, a PDCCH with an aggregation level 16 meaning 16 CCEs can be formed from the CCEs from these two slots.

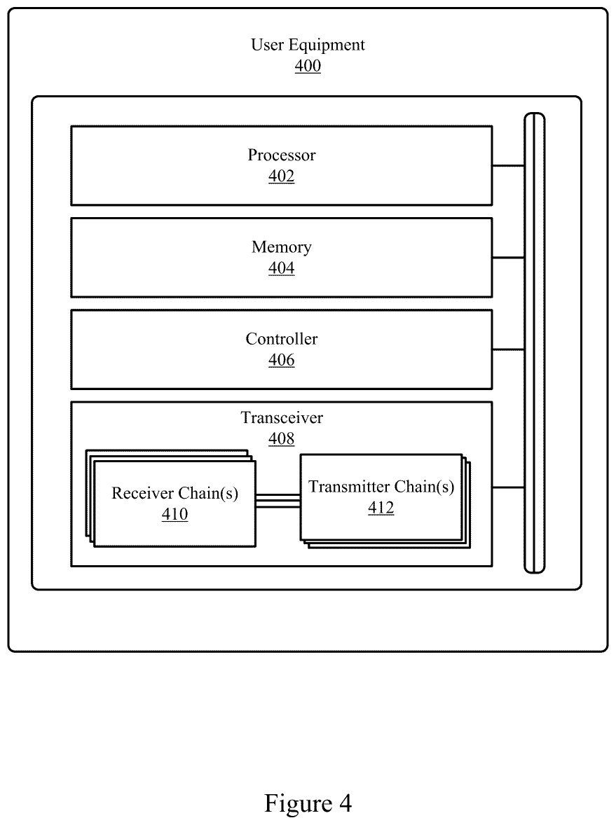

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such as the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein. The UE 400 may be configured to or operable to support a means for requesting an OD-SIB1 activation for a cell using an invalid monitoring occasion for search space monitoring, activating the OD-SIB1 using the invalid monitoring occasion as part of the search space monitoring occasion indication, and/or determining whether to monitor a PDCCH occasion associated with the OD-SIB1. The search space monitoring occasion indication may be part of a MIB payload.

Additionally, the UE 400 may be configured to support any one or combination of where monitoring a DL WUS occasion, receiving indication on the DL WUS on whether to start PDCCH monitoring in a search space associated with a SI-RNTI of the OD-SIB1, receiving monitoring occasions for the search space monitoring related to a SI-RNTI as part of the MIB payload, monitoring the PDCCH occasion associated with the OD-SIB1 upon determining that the monitoring occasions for the search space monitoring related to the SI-RNTI is valid, receiving a change of the MIB payload associated with the search space associated with a SI-RNTI of the OD-SIB1, and/or receiving indication on a DL WUS on whether to start the PDCCH monitoring occasion associated with a SI-RNTI of the OD-SIB1. The DL WUS occasion may be a group common associated with a SI-RNTI of the OD-SIB1. The change of the MIB payload may be determined by comparing a MIB payload from a previous MIB occasion or MIB modification period. The change of the MIB payload may mean content of the search space monitoring occasions associated with the SI-RNTI is changed from invalid to valid.

Additionally, or alternatively, the UE 400 may support at least one memory (e.g., the memory 404) and at least one processor (e.g., the processor 402) coupled with the at least one memory and configured to cause the UE to request an on-demand system information block type 1 (OD-SIB1) activation for a cell using an invalid monitoring occasion for search space monitoring. Search space monitoring occasion indication may be part of a master information block (MIB) payload. The UE may activate the OD-SIBI using the invalid monitoring occasion as part of the search space monitoring occasion indication. The UE may determine whether to monitor a physical downlink control channel (PDCCH) occasion associated with the OD-SIB1.

Additionally, the UE 400 may be configured to support any one or combination of where the UE may monitor a DL WUS occasion. The DL WUS occasion may be a group common associated with a SI-RNTI of the OD-SIB1. The UE may receive indication on the DL WUS on whether to start PDCCH monitoring in a search space associated with a SI-RNTI of the OD-SIB1. The UE may receive monitoring occasions for the search space monitoring related to a SI-RNTI as part of the MIB payload. Upon determining that the monitoring occasions for the search space monitoring related to the SI-RNTI is valid, the UE may monitor the PDCCH occasion associated with the OD-SIB1. The UE may also receive a change of the MIB payload associated with the search space associated with a SI-RNTI of the OD-SIB1. The change of the MIB payload may be determined by comparing a MIB payload from a previous MIB occasion or MIB modification period. The change of the MIB payload may mean content of the search space monitoring occasions associated with the SI-RNTI is changed from invalid to valid. The UE may receive indication on a DL WUS on whether to start the PDCCH monitoring occasion associated with a SI-RNTI of the OD-SIB1.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas to receive a signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

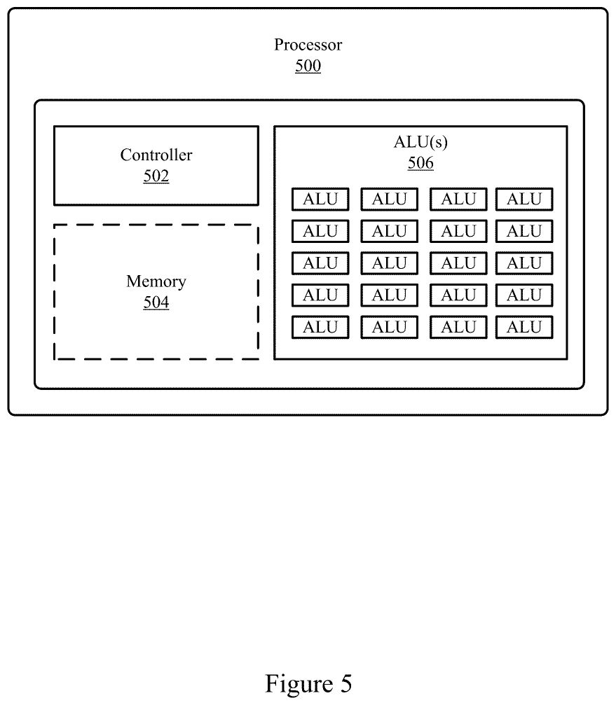

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory addresses of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, ALUs 506, and other functional units of the processor 500.

The memory 504 may include one or more caches (e.g., memory local to or included in the processor 500 or other memory, such as RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, and the controller 502, and may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 may be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. The processor 500 may be configured to or operable to support at least one controller (e.g., the controller 502) coupled with at least one memory (e.g., the memory 504) and configured to cause the processor to provide a cell with an OD-SIBI activation using an invalid monitoring occasion for search space monitoring, and activate the OD-SIBI using the invalid monitoring occasion as part of the search space monitoring occasion indication. The search space monitoring occasion indication may be part of a MIB payload.

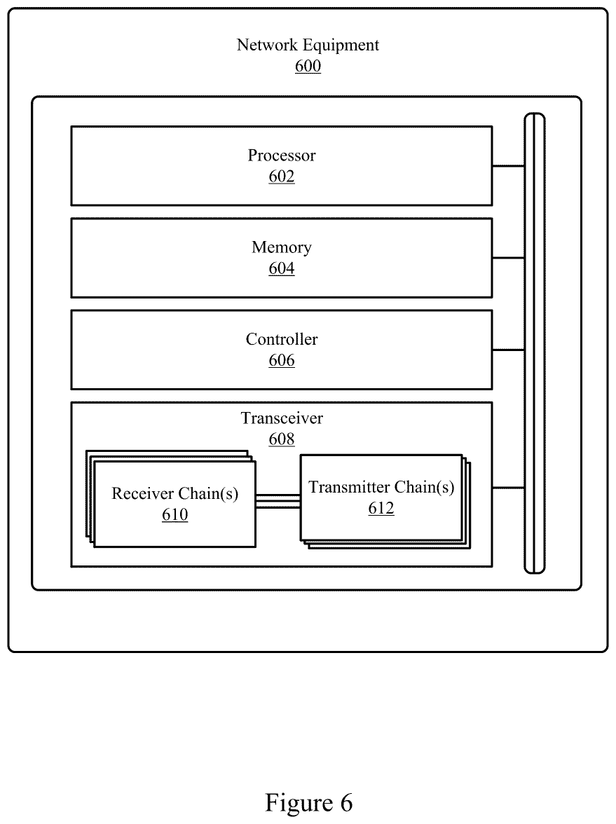

FIG. 6 illustrates an example of an NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein. The NE 600 may be configured to or operable to support a means for providing a cell with an OD-SIBI activation using an invalid monitoring occasion for search space monitoring, and activating the OD-SIBI using the invalid monitoring occasion as part of the search space monitoring occasion indication. The search space monitoring occasion indication may be part of a MIB payload.

Additionally, or alternatively, the NE 600 may support at least one memory (e.g., the memory 604) and at least one processor (e.g., the processor 602) coupled with the at least one memory and configured to cause the NE to provide a cell with an OD-SIBI activation using an invalid monitoring occasion for search space monitoring, and activate the OD-SIB1 using the invalid monitoring occasion as part of the search space monitoring occasion indication. The search space monitoring occasion indication may be part of a MIB payload.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

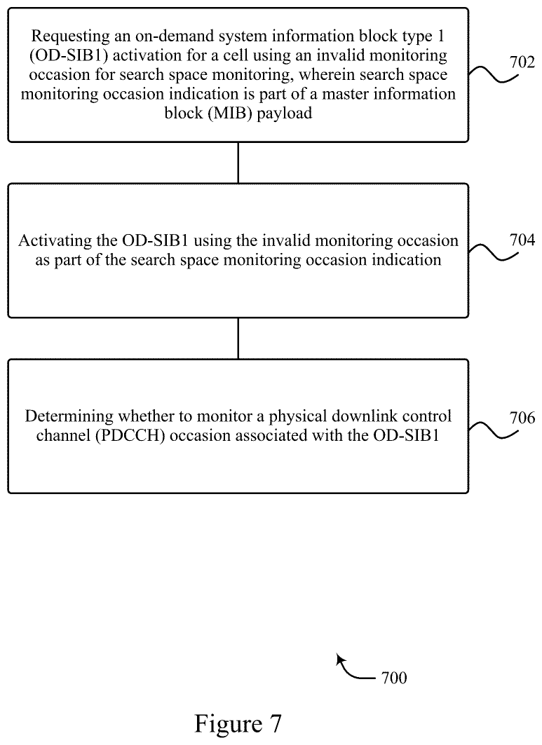

FIG. 7 illustrates a flowchart of a method 700 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 702, the method may include requesting an OD-SIBI activation for a cell using an invalid monitoring occasion for search space monitoring, where search space monitoring occasion indication is part of a MIB payload. The operations of 702 may be performed in accordance with examples as described herein. In some implementations, aspects of the operations of 702 may be performed by a UE as described with reference to FIG. 4.

At 704, the method may include activating the OD-SIBI using the invalid monitoring occasion as part of the search space monitoring occasion indication. The operations of 704 may be performed in accordance with examples as described herein. In some implementations, aspects of the operations of 704 may be performed by a UE as described with reference to FIG. 4.

At 706, the method may include determining whether to monitor a PDCCH occasion associated with the OD-SIB1. The operations of 706 may be performed in accordance with examples as described herein. In some implementations, aspects of the operations of 706 may be performed a UE as described with reference to FIG. 4.

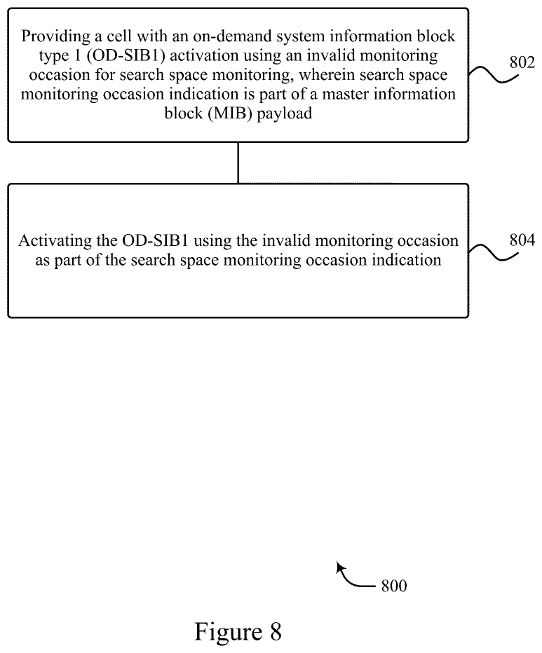

FIG. 8 illustrates a flowchart of a method 800 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 802, the method may include providing a cell with an OD-SIBI activation using an invalid monitoring occasion for search space monitoring, where the search space monitoring occasion indication is part of a MIB payload. The operations of 802 may be performed in accordance with examples as described herein. In some implementations, aspects of the operations of 802 may be performed by an NE as described with reference to FIG. 6.

At 804, the method may include activating the OD-SIBI using the invalid monitoring occasion as part of the search space monitoring occasion indication. The operations of 804 may be performed in accordance with examples as described herein. In some implementations, aspects of the operations of 804 may be performed by an NE as described with reference to FIG. 6.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
request an on-demand system information block type 1 (OD-SIB1) activation for a cell using an invalid monitoring occasion for search space monitoring, wherein search space monitoring occasion indication is part of a master information block (MIB) payload;
activate the OD-SIB1 using the invalid monitoring occasion as part of the search space monitoring occasion indication; and
determine whether to monitor a physical downlink control channel (PDCCH) occasion associated with the OD-SIB1.

2. The UE of claim 1, wherein the at least one processor is operable to cause the UE to monitor a downlink (DL) wake-up signal (WUS) occasion, the DL WUS occasion is a group common associated with a system information radio network temporary identifier (SI-RNTI) of the OD-SIB1.

3. The UE of claim 2, wherein the at least one processor is operable to cause the UE to receive indication on the DL WUS on whether to start PDCCH monitoring in a search space associated with a SI-RNTI of the OD-SIB1.

4. The UE of claim 1, wherein the at least one processor is operable to cause the UE to receive monitoring occasions for the search space monitoring related to a SI-RNTI as part of the MIB payload.

5. The UE of claim 4, wherein the at least one processor is operable to cause the UE to upon determining that the monitoring occasions for the search space monitoring related to the SI-RNTI is valid, monitor the PDCCH occasion associated with the OD-SIB1.

6. The UE of claim 1, wherein the at least one processor is operable to cause the UE to receive a change of the MIB payload associated with the search space associated with a SI-RNTI of the OD-SIB1.

7. The UE of claim 6, wherein the change of the MIB payload is determined by comparing a MIB payload from a previous MIB occasion or MIB modification period.

8. The UE of claim 6, wherein the change of the MIB payload means content of the search space monitoring occasions associated with the SI-RNTI is changed from invalid to valid.

9. The UE of claim 1, wherein the at least one processor is operable to cause the UE to receive indication on a DL WUS on whether to start the PDCCH monitoring occasion associated with a SI-RNTI of the OD-SIB1.

10. A network equipment (NE) for wireless communication, comprising:
at least one memory; and
at least one processor coupled with the at least one memory and operable to cause the NE to:
provide a cell with an on-demand system information block type 1 (OD-SIB1) activation using an invalid monitoring occasion for search space monitoring, wherein search space monitoring occasion indication is part of a master information block (MIB) payload; and
activate the OD-SIB1 using the invalid monitoring occasion as part of the search space monitoring occasion indication.

11. A method performed by a user equipment (UE), the method comprising:
requesting an on-demand system information block type 1 (OD-SIB1) activation for a cell using an invalid monitoring occasion for search space monitoring, wherein search space monitoring occasion indication is part of a master information block (MIB) payload;
activating the OD-SIB1 using the invalid monitoring occasion as part of the search space monitoring occasion indication; and
determining whether to monitor a physical downlink control channel (PDCCH) occasion associated with the OD-SIB1.

12. The method of claim 11, further comprising monitoring a downlink (DL) wake-up signal (WUS) occasion, the DL WUS occasion is a group common associated with a system information radio network temporary identifier (SI-RNTI) of the OD-SIB1.

13. The method of claim 12, further comprising receiving indication on the DL WUS on whether to start PDCCH monitoring in a search space associated with a SI-RNTI of the OD-SIB1.

14. The method of claim 11, further comprising receiving monitoring occasions for the search space monitoring related to a SI-RNTI as part of the MIB payload.

15. The method of claim 14, further comprising upon determining that the monitoring occasions for the search space monitoring related to the SI-RNTI is valid, monitoring the PDCCH occasion associated with the OD-SIB1.

16. The method of claim 15, further comprising receiving a change of the MIB payload associated with the search space associated with a SI-RNTI of the OD-SIB1.

17. The method of claim 16, wherein the change of the MIB payload is determined by comparing a MIB payload from a previous MIB occasion or MIB modification period.

18. The method of claim 16, wherein the change of the MIB payload means content of the search space monitoring occasions associated with the SI-RNTI is changed from invalid to valid.

19. The method of claim 11, further comprising receiving indication on a DL WUS on whether to start the PDCCH monitoring occasion associated with a SI-RNTI of the OD-SIB1.

20. A method performed by a network equipment (NE), the method comprising:
providing a cell with an on-demand system information block type 1 (OD-SIB1) activation using an invalid monitoring occasion for search space monitoring, wherein search space monitoring occasion indication is part of a master information block (MIB) payload; and
activating the OD-SIB1 using the invalid monitoring occasion as part of the search space monitoring occasion indication.
